(19) United States
(12) Patent Application Publication
(10) Pub. No.: US 2026/0225316 A1
(43) Pub. Date: Aug. 6, 2026

(54) MODULAR AND MOBILE ADDITIVE BATTERY MANUFACTURING SYSTEM

(71) Applicant: MATERIAL HYBRID MANUFACTURING, INC., Miami, FL (US)

(72) Inventors: Christopher Reyes, San Marcos, TX (US); Gabriel Elias, Miami Beach, FL (US); Miles Dotson, Oakland, CA (US); Antonio Nicolas Briceno, Miami, FL (US)

(21) Appl. No.: 19/532,964

(22) Filed: Feb. 6, 2026

Related U.S. Application Data
(60) Provisional application No. 63/755,113, filed on Feb. 6, 2025.

(51) Int. Cl. B29C 64/336; B29C 64/209; B29C 64/227; B29C 64/25; B29C 64/393; B33Y 30/00; B33Y 50/02; B33Y 80/00

(52) U.S. Cl. CPC B29C 64/336; B29C 64/209; B29C 64/227; B29C 64/25; B29C 64/393; B33Y 30/00; B33Y 50/02; B33Y 80/00

(57) ABSTRACT

Disclosed herein is a 3D printing system for 3D printing batteries. The 3D printing system includes: A modular materials unit that includes multiple multi-material reservoirs that are configured to contain multiple battery materials separately. A modular printing unit with interchangeable deposition nozzles that receive material from the modular materials unit and eject the material towards a platform of the modular printing unit. A controller that selectively causes the modular materials unit to supply the multiple battery materials to the modular printing unit and the interchangeable deposition nozzles to eject the material. A power unit that supplies power to the 3D printing system. A sealed enclosure that contains the modular materials unit, the modular printing unit, the controller, and energy storage components of the power unit. And a mobility mechanism that attaches the sealed enclosure to mobility devices that can transport the 3D printing system to a desired location.

### CROSS-REFERENCE TO RELATED APPLICATIONS

This application claims priority to and benefit from U.S. Provisional Ser. No. 63/755,113 , entitled “Modular and Mobile Additive Battery Manufacturing System for Rapid Factory Configuration and Forward Deployment,” filed on Feb. 6, 2025, which is hereby incorporated by reference in its entirety.

### BACKGROUND

Batteries are electrochemical devices that convert chemical energy into electrical energy through redox reactions. A battery typically comprises one or more electrochemical cells, each containing an anode (negative electrode), a cathode (positive electrode), a separator positioned between the electrodes, and an electrolyte that facilitates ion transport between the electrodes. During discharge, chemical reactions at the electrodes generate electrons that flow through an external circuit to power electrical devices. Rechargeable batteries, also known as secondary batteries, can reverse these reactions during charging to restore the stored chemical energy. Various battery chemistries exist, including lithium-ion, nickel-metal hydride, and lead-acid, each offering different characteristics in terms of energy density, power density, cycle life, and operating conditions. Batteries find application across numerous domains, from portable consumer electronics and electric vehicles to grid-scale energy storage systems.

### BRIEF DESCRIPTION OF THE DRAWINGS

Reference will now be made, by way of example, to the accompanying drawings which show example embodiments of the present application, and in which:

FIG. 1 is a simplified block diagram of a modular and mobile additive battery manufacturing system in accordance with various embodiments of the present technology.

FIG. 2 is a block diagram of example mobility devices of a modular and mobile additive battery manufacturing system in accordance with various embodiments of the present technology.

FIG. 3 is a block diagram of a modular and mobile additive battery manufacturing system in accordance with various embodiments of the present technology.

FIG. 4 is a block diagram of a remote control and monitoring environment of a modular and mobile additive battery manufacturing system in accordance with various embodiments of the present technology.

FIG. 5 is a flowchart of steps carried out by a 3D printing system when printing a battery in accordance with various embodiments of the present technology.

FIG. 6 is a block diagram that illustrates an example of a computer system in which at least some operations described herein can be implemented.

FIG. 7 is a block diagram that illustrates an example of an AI system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology relates to additive manufacturing systems for battery production and, more specifically, to a modular and mobile 3D printing system capable of on-demand battery manufacturing in diverse environments. This system is designed for deployment in terrestrial, maritime, aerospace, and extraterrestrial applications.

Modern battery production relies on fixed-location manufacturing facilities that require substantial infrastructure, specialized equipment, and extended setup periods. These conventional factories are designed for high-volume production in controlled environments, with supply chains optimized for stable, long-term operations at permanent sites.

The demand for batteries continues to expand across numerous sectors, including consumer electronics, electric vehicles, aerospace systems, military applications, and emergency response operations. In many scenarios, the need for battery power arises in locations that are remote, temporary, or otherwise unsuitable for traditional manufacturing infrastructure. Examples include military operating bases, disaster relief zones, offshore platforms, research stations in extreme environments, and space-based installations.

Transporting batteries to remote or inaccessible locations presents logistical challenges, including extended supply chain timelines, storage requirements, and the risk of supply disruption. In some environments, such as extraterrestrial settings or deep-sea installations, the transportation of pre-manufactured batteries may be impractical or cost-prohibitive.

Additive manufacturing, commonly referred to as 3D printing, has emerged as a technology capable of producing complex components with reduced material waste and increased design flexibility. Additive manufacturing techniques have been applied to various industries, including aerospace, medical devices, and consumer products. The application of additive manufacturing to battery production offers potential advantages in terms of customization, on-site fabrication, and reduced dependency on centralized supply chains.

However, existing additive manufacturing systems are generally designed for operation in controlled factory environments with stable power supplies, climate control, and fixed infrastructure. These systems may not be readily adaptable to mobile deployment, harsh environmental conditions, or operation in non-terrestrial settings where factors such as reduced gravity, vacuum conditions, or radiation exposure present additional challenges.

Accordingly, disclosed herein is a modular and mobile 3D printing system for 3D printing batteries. The 3D printing system includes: (1) a modular materials unit that includes multiple multi-material reservoirs that are each configured to contain multiple battery materials separately. For example, the reservoirs can contain separate spools of battery casing materials, anode materials, separator materials, cathode materials, and etc. (2) a modular printing unit with interchangeable deposition nozzles that receive material from the modular materials unit and eject the material towards a platform of the modular printing unit. In some embodiments, the modular printing unit includes drive mechanism that positions the interchangeable deposition nozzles over a surface of the platform during the printing process. (3) a controller that selectively causes the modular materials unit to supply the multiple battery materials to the modular printing unit, causes the interchangeable deposition nozzles to eject the material, and causes the drive mechanism to position the interchangeable deposition nozzles over the platform surface. (4) a power unit that supplies power to the 3D printing system. (5) a sealed enclosure that contains the modular materials unit, the modular printing unit, the controller, and energy storage components of the power unit. And (6) a mobility mechanism that attaches the sealed enclosure to one or more mobility devices (e.g., a truck, a plane, a ship, a train) that can transport the 3D printing system to a desired location.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

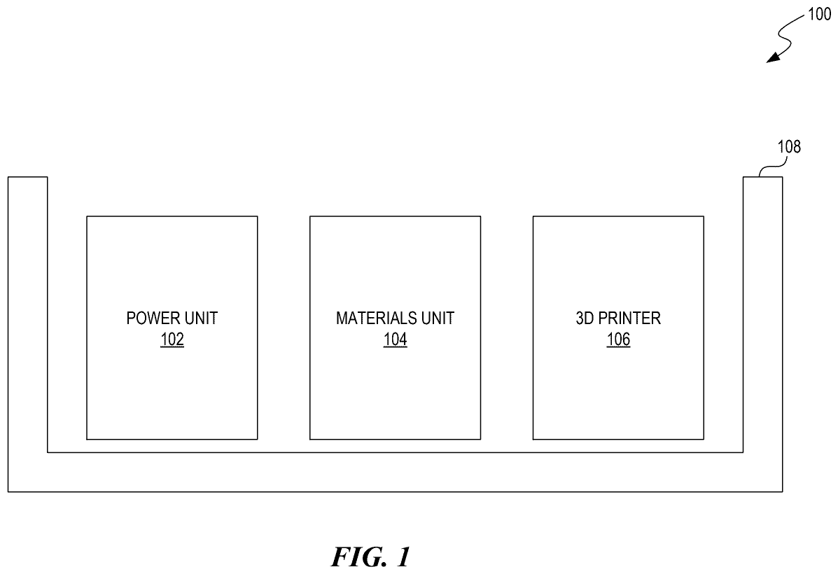

FIG. 1 is a simplified block diagram of a modular and mobile additive battery manufacturing system 100 (also referred to herein as “a 3D printing system 100”). The 3D printing system 100 includes a power unit 102, a materials unit 104, a 3D printer 106, and an enclosure 108. The 3D printing system 100 is configured for on-demand battery manufacturing in diverse environments, including terrestrial, maritime, aerospace, and extraterrestrial settings.

The power unit 102 provides electrical energy to operate the components of the 3D printing system 100. In some embodiments, the power unit 102 includes energy generation components, energy storage components, or both. In other embodiments, the power unit 102 is configured to supply power to the materials unit 104, the 3D printer 106, and other components housed within the enclosure 108.

The materials unit 104 stores and supplies the various materials used in the battery manufacturing process. In some embodiments, the materials unit 104 includes multiple reservoirs (also referred to herein as “multi-material reservoirs”) configured to contain different battery materials separately. The materials unit 104 may supply materials such as battery casing materials, anode materials, separator materials, and cathode materials-as well as other battery materials like electrolyte materials-to the 3D printer 106 during the additive manufacturing process.

The 3D printer 106 performs the printing operations to produce batteries using materials supplied by the materials unit 104. Across various embodiments, the 3D printer 106 includes one or more deposition nozzles, a platform, and a drive mechanism that positions the deposition nozzles over a surface of the platform during the printing process. The 3D printer 106 is configured to fabricate batteries in various form factors and configurations based on instructions received from a controller.

The enclosure 108 houses the power unit 102 (or portions thereof), the materials unit 104, and the 3D printer 106, providing a contained environment for the manufacturing operations. In some embodiments, the enclosure 108 is sealed to protect the internal components from environmental conditions such as dust, moisture, temperature extremes, and radiation. In other embodiments, the enclosure 108 is pressurized to enable operation in low-pressure or vacuum environments.

The power unit 102, the materials unit 104, and the 3D printer 106 are arranged within the enclosure 108 in a modular configuration. The modular configuration allows individual components to be swapped out, replaced, or reconfigured within the enclosure 108 without requiring replacement of the entire 3D printing system 100. For example, the materials unit 104 may be exchanged for a different materials unit configured to store alternative battery chemistries. Similarly, the 3D printer 106 may be replaced with a different printer configuration suited for a particular battery form factor or manufacturing process. The power unit 102 may also be exchanged to accommodate different power generation or storage requirements based on the deployment environment.

The modular architecture of the 3D printing system 100 enables reconfiguration and deployment across various environments. In some embodiments, the modular components are designed with standardized interfaces that facilitate rapid installation and removal. The modular design is expected to reduce downtime during maintenance, enable field-level repairs, and allow the 3D printing system 100 to be adapted for different mission requirements without returning to a centralized facility.

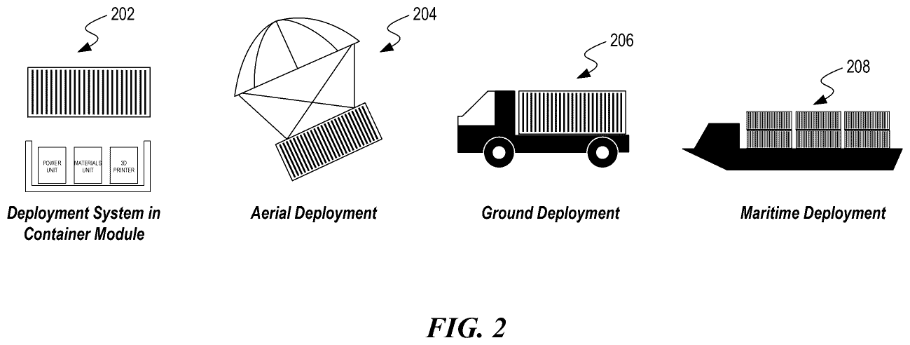

FIG. 2 is a block diagram of example mobility devices of a modular and mobile additive battery manufacturing system (e.g., the 3D printing system 100 of FIG. 1). The 3D printing system may be deployed in various configurations to enable transportation and operation across different environments. FIG. 2 illustrates a handful of example mobility devices for the present technology including a deployment system in container module 202, an aerial deployment 204, a ground deployment 206, and a maritime deployment 208. These deployment configurations demonstrate the transportability and adaptability of the 3D printing system across different operational environments.

The deployment system in container module 202 includes a shipping container that houses the 3D printing system (e.g., the 3D printing system 100). In some embodiments, the enclosure (e.g., the enclosure 108 of FIG. 1) of the 3D printing system is configured to fit within the container module 202, such that the container module 202 serves as an outer protective shell during transportation. In other embodiments, the 3D printing system is enclosed by the container module 202 itself, with the container module 202 functioning as the sealed enclosure.

Example of containers that the 3D printing system may deployed in other than a container module include custom-designed enclosures, modular housing units, or other protective structures configured for specific deployment scenarios. The selection of container type may depend on factors such as the transportation method, deployment environment, and operational requirements.

To attach to a mobility device, the 3D printing system includes a mobility mechanism. In some embodiments, the mobility mechanism is an additional component that is secured to an enclosure of the 3D printing system (e.g., a custom enclosure or a container module). In other embodiments, the mobility mechanism is integrated into the enclosure of the 3D printing system.

The mobility mechanism of the present technology can attach the 3D printing system to a variety of mobility devices that are configured to transport the 3D printing system to a desired location. Example mobility devices include an automobile (e.g., a semi-truck), a train (e.g., as a car of a train), a train track (e.g., track upon which the mobility mechanism—i.e., wheels and a motor—of the 3D printing system sit), an airplane, a drone, a ship, a magnetically levitated mobility device, and a high-altitude balloon.

The aerial deployment 204 illustrates the 3D printing system within the container module 202 descending via a parachute system for airborne delivery. In some embodiments, the 3D printing system is transported by cargo aircraft and deployed via parachute to remote or inaccessible locations. The aerial deployment 204 enables rapid positioning of the 3D printing system in areas where ground-based transportation is impractical or unavailable. In other embodiments, the mobility mechanism includes VTOL (vertical take-off and landing) drone deployment capability for high-altitude or inaccessible regions. VTOL drones may transport the 3D printing system or components thereof to locations that lack suitable landing strips or road access.

The ground deployment 206 shows the container module 202 mounted on a wheeled truck platform for land-based transportation and operation. In some embodiments, the mobility mechanism attaches the sealed enclosure to an automobile, such as a truck, trailer, or other wheeled vehicle. The ground deployment 206 enables the 3D printing system to be transported along roadways and positioned at terrestrial sites for battery manufacturing operations. In other embodiments, the mobility mechanism attaches the enclosure to a train or interfaces with a train track for rail-based transportation. Rail-mounted configurations may be used for transporting the 3D printing system across long distances or to locations served by rail infrastructure.

The maritime deployment 208 depicts multiple container modules positioned on a ship vessel for sea-based manufacturing operations. In some embodiments, the mobility mechanism attaches the enclosure to a ship for maritime transportation and deployment. The maritime deployment 208 enables offshore battery production for naval fleets, commercial vessels, and offshore installations.

In additional embodiments, the mobility mechanism includes a magnetic levitation (mag-lev) configuration that can be used for zero-gravity and space applications. The 3D printing system may be transported via rocket into space and deployed on orbital platforms or extraterrestrial installations. The 3D printing system is ISS-compatible for battery production during space missions, enabling on-demand energy storage manufacturing in low-Earth orbit. Magnetically levitated mobility devices may be used in space-based or extraterrestrial environments where conventional wheeled or tracked mobility mechanisms are unsuitable.

Further, the mobility mechanism may also attach the enclosure to a high-altitude balloon for deployment at elevated altitudes. High-altitude balloon deployment enables the 3D printing system to operate in near-space environments or to reach locations that are inaccessible by conventional aircraft.

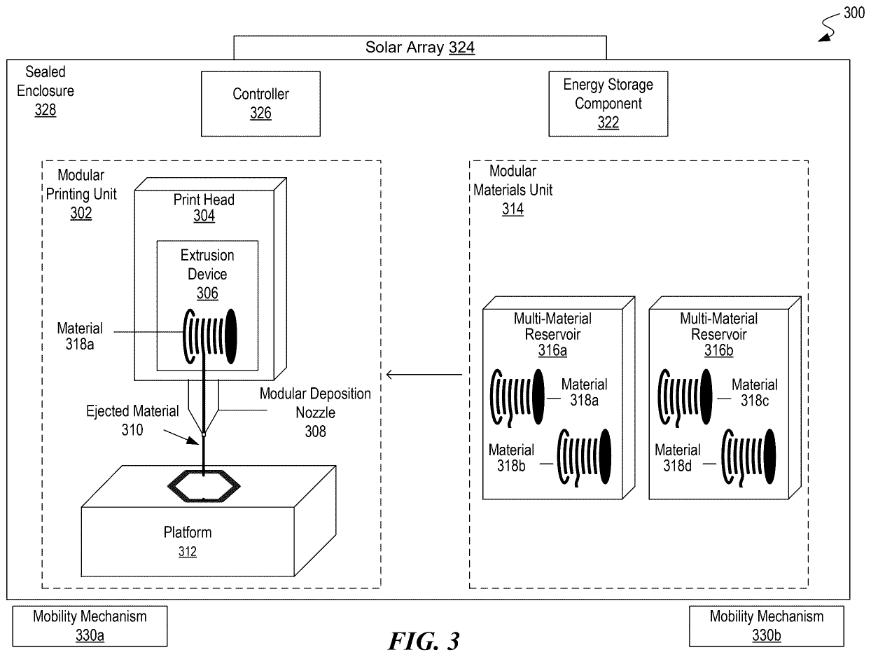

FIG. 3 is a block diagram of a modular and mobile additive battery manufacturing system 300 (also referred to herein as “a 3D printing system 300”). The 3D printing system 300 includes a modular printing unit 302 that performs additive manufacturing operations to fabricate batteries. The modular printing unit 302 includes a print head 304, an extrusion device 306, a modular deposition nozzle 308, ejected material 310, and a platform 312. The 3D printing system 300 also includes a modular materials unit 314 that stores and supplies the various materials used in the battery manufacturing process. The modular materials unit 314 includes a first multi-material reservoir 316a and a second multi-material reservoir 316b. The first multi-material reservoir 316a stores a first material 318a and a second material 318b while the second multi-material reservoir 316b stores a third material 318c and a fourth material 318d.

The 3D printing system 300 also includes a power unit that provides electrical energy to operate the components of the 3D printing system 300. The power unit includes an energy generation component and a regenerative energy storage component. In FIG. 3, the power unit comprises an energy storage component 322 and a solar array 324. Further, the 3D printing system 300 includes a controller 326 that manages the overall operation of the 3D printing system 300. Additionally, as shown, the 3D printing system 300 includes a sealed enclosure 328 as well as a mobility mechanism 330 (represented by mobility mechanisms 330a and 330b).

Turning to the modular printing unit 302. The print head 304 houses the extrusion device 306. The extrusion device 306 is connected to the modular deposition nozzle 308. The extrusion device 306 may control the flow rate and deposition characteristics of the material 318a as the material 318a passes through the print head 304. The print head 304 may contain more than one extrusion device 306 to control the deposition of more than one material at a time. The modular deposition nozzle 308 is configured to receive a material of multiple battery materials from the modular materials unit 314 and eject the material towards a surface of the platform 312. The platform 312 serves as the build surface for the additive manufacturing process.

Additionally, the modular printing unit 302 includes a drive mechanism (not shown) that is configured to position the modular deposition nozzle 308 over the surface of the platform 312. The drive mechanism may include motors, linear actuators, gantry systems, or robotic arms that move the print head 304 and the modular deposition nozzle 308 along multiple axes relative to the platform 312. In some embodiments, the drive mechanism positions the modular deposition nozzle 308 in three-dimensional space to enable precise deposition of the ejected material 310 at specified locations on the surface of the platform 312. In other embodiments, the drive mechanism adjusts the angle or position of the modular deposition nozzle 308 relative to the print head 304. In yet further embodiments, the drive mechanism additionally or alternatively moves the platform 312 itself, providing positioning capability through movement of the build surface rather than or in addition to movement of the print head 304 or the material deposition nozzle 308. The controller 326 may coordinate operation of the drive mechanism with material deposition from the print head 304 to achieve precise placement of the ejected material 310 according to a predetermined fabrication pattern.

The modular deposition nozzle 308 is interchangeable. In some embodiments, the modular printing unit 302 includes one or more interchangeable deposition nozzles that are each configured to receive a material of the multiple battery materials and eject the material towards the surface of the platform 312. The interchangeable configuration of the modular deposition nozzle 308 allows different nozzles to be installed in the print head 304 depending on the battery chemistry being processed. For example, a first interchangeable deposition nozzle may be designed for depositing cathode materials, while a second interchangeable deposition nozzle may be designed for depositing anode materials or solid-state electrolyte materials. The interchangeable deposition nozzles may have different orifice sizes, material flow rates, or heating elements suited for particular battery materials.

In some embodiments, the modular printing unit 302 includes interchangeable deposition heads designed for different battery chemistries. The interchangeable deposition heads may be swapped to accommodate various material types, including lithium-metal anodes, solid-state electrolytes, and experimental battery chemistries. The modularity of the deposition heads and nozzles enables the 3D printing system 300 to produce batteries with different chemical compositions without requiring replacement of the entire modular printing unit 302.

The modular printing unit 302 includes advanced print control algorithms for layer-by-layer fabrication of batteries. In some embodiments, a controller (e.g., the controller 326 shown in FIG. 3) executes the print control algorithms to coordinate the operation of the extrusion device 306, the modular deposition nozzle 308, and the drive mechanism. The print control algorithms may control parameters such as material flow rate, deposition speed, layer thickness, and nozzle temperature to achieve precise fabrication of battery structures. The print control algorithms may also coordinate the sequential deposition of different battery materials to form complete battery cells, including battery casing layers, anode layers, separator layers, and cathode layers.

As described previously, the modular printing unit 302 includes a platform 312 having a surface upon which the ejected material 310 is deposited. The surface of the platform 312 may be configured with features that facilitate adhesion of the initial layer of deposited material and enable removal of completed battery components after fabrication. In some embodiments, the platform 312 includes a heated surface to maintain deposited materials at a target temperature during the printing process. During printing operations, the modular deposition nozzle 308 deposits ejected material 310 onto the platform 312 in a controlled manner to form battery components layer by layer.

Turning to the modular materials unit 314, the modular materials unit 314 includes the first multi-material reservoir 316a and the second multi-material reservoir 316b. The first multi-material reservoir 316a stores the first material 318a and the second material 318b. The second multi-material reservoir 316b stores the third material 318c and the fourth material 318d. Each multi-material reservoir is configured to contain the respective materials separately, such that different battery materials do not mix within the reservoir prior to deposition.

The multiple battery materials stored in the modular materials unit 314 may include a battery casing material, an anode material, a separator material, and a cathode material. In some embodiments, the first material 318a comprises a battery casing material, the second material 318b comprises an anode material, the third material 318c comprises a separator material, and the fourth material 318d comprises a cathode material. In other embodiments, the materials—as well as the material types—may be arranged differently among the multi-material reservoirs depending on the battery configuration being fabricated. The modular configuration of the multi-material reservoirs enables the 3D printing system 300 to produce batteries with different chemical compositions by swapping or reconfiguring the reservoirs within the modular materials unit 314 or simply by including enough material within the multi-material reservoirs to fabricate more than one type of battery.

The multi-material reservoirs of the modular materials unit 314 may contain any combination of battery materials. For example, the first multi-material reservoir 316a can contain a first subset of battery materials such as solid-state electrolyte materials while the second multi-material reservoir 316b can contain a second subset of battery materials such as electrode materials. Though shown with two multi-material reservoirs, the present technology is not so limited. Accordingly, the modular materials unit 314, in some embodiments, includes a third multi-material reservoir (e.g., one that contains a third subset of battery materials such as battery casing materials) and a fourth multi-material reservoir (e.g., one that contains a fourth subset of battery materials such as separator materials).

As described above, beyond the battery casing material, the anode material, the separator material, and the cathode material, the multi-material reservoirs 316 may store other materials used in battery fabrication. In some embodiments, the multi-material reservoirs 316 contain electrolyte materials, current collector materials, binder materials, or conductive additive materials. Further, the multi-material reservoirs 316 may be configured to accommodate various material forms, including powders, pastes, filaments, or liquid precursors, depending on the deposition method employed by the modular printing unit 302.

As shown in FIG. 3, the modular materials unit 314 supplies the multiple battery materials to the modular printing unit 302 during the additive manufacturing process. In some embodiments, the modular materials unit 314 includes feed mechanisms that transport materials from the multi-material reservoirs to the print head 304 and the modular deposition nozzle 308. The feed mechanisms may include pumps, augers, pneumatic systems, or other material handling devices configured to deliver materials at controlled rates to the extrusion device 306.

In some embodiments, the 3D printing system 300 includes an automated process flow for material preparation, printing, curing, and packaging of batteries. In such embodiments, the controller 326 coordinates the automated process flow by controlling the modular materials unit 314 to supply materials, controlling the modular printing unit 302 to deposit the ejected material 310 onto the platform 312, and controlling post-processing operations such as curing and packaging. The automated process flow enables the 3D printing system 300 to produce batteries with minimal manual intervention, which may be advantageous for deployment in remote or hazardous environments.

In some embodiments, the 3D printing system 300 includes a power unit that provides electrical energy to operate the components of the 3D printing system 300. The power unit includes an energy generation component and a regenerative energy storage component. As shown in FIG. 3, the power unit can include an energy storage component 322 and a solar array 324.

The solar array 324 is positioned on an exterior surface of the sealed enclosure 328. The solar array 324 collects solar radiation and converts the solar radiation into electrical energy. The electrical energy generated by the solar array 324 is used to power the modular printing unit 302, the modular materials unit 314, the controller 326, and other components of the 3D printing system 300.

The energy storage component 322 stores energy collected from the solar array 324 for use during operation. The energy storage component 322 is a regenerative energy storage component. In some embodiments, the regenerative energy storage component is a battery energy storage system. The battery energy storage system provides energy to one or more of the modular materials unit 314, the modular printing unit 302, and the controller 326. The energy storage component 322 enables the 3D printing system 300 to continue operating when the solar array 324 is not generating sufficient power, such as during nighttime hours or periods of reduced solar irradiance. The combination of the solar array 324 and the energy storage component 322 provides off-grid functionality, enabling the 3D printing system 300 to operate in locations without access to external power infrastructure.

In some embodiments, the energy generation component comprises an electrical couple configured to electrically couple the power unit to an energy generation device. The electrical couple enables the power unit to receive electrical energy from external energy generation devices when such devices are available. The energy generation device may include generators, grid connections, or other power sources that supplement or replace the solar array 324 (e.g., an on-site solar array).

The power unit may integrate directly with renewable energy sources. In some embodiments, the power unit integrates with hydro power generation systems that convert energy from flowing water into electrical energy. In other embodiments, the power unit integrates with wind power generation systems that convert wind energy into electrical energy. In yet further embodiments, the power unit integrates with nuclear microreactors that generate electrical energy from nuclear reactions. The integration with these renewable energy sources enables the 3D printing system 300 to operate in diverse environments where different energy resources are available.

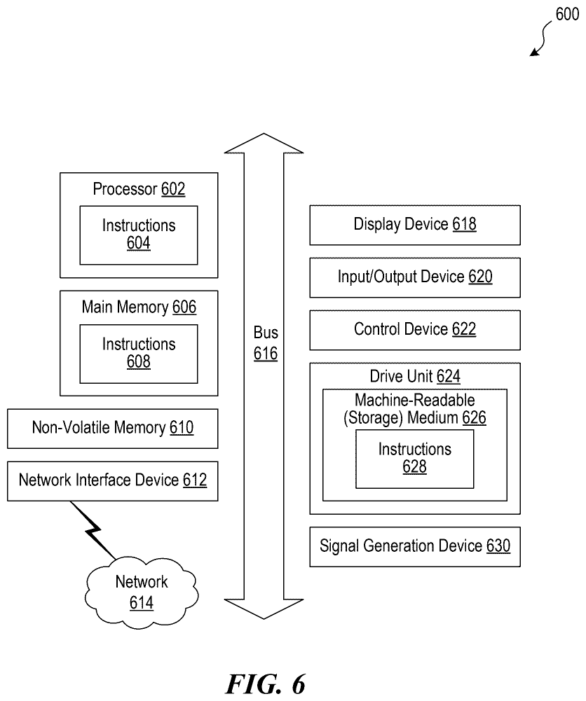

The controller 326 manages the overall operation of the 3D printing system 300. The controller 326 coordinates the printing process by controlling the modular printing unit 302, the modular materials unit 314, and the power unit. The controller 326 executes instructions that govern the sequence of operations during battery fabrication, including material delivery, deposition, and positioning of components within the 3D printing system 300. In some embodiments, the controller 326 is a computer system similar to the computing system 600 described below with respect to FIG. 6.

The controller 326 is configured to selectively cause the modular materials unit 314 to supply the multiple battery materials (i.e., materials 318a-318d) to the modular printing unit 302. In some embodiments, the controller 326 sends control signals to the modular materials unit 314 that activate feed mechanisms within the first multi-material reservoir 316a and the second multi-material reservoir 316b. The control signals may specify which of the first material 318a, the second material 318b, the third material 318c, or the fourth material 318d is to be supplied to the modular printing unit 302 at a given time during the printing process. The controller 326 may selectively cause the modular materials unit 314 to supply the multiple battery materials to one or more interchangeable deposition nozzles of the modular printing unit 302 based on the battery configuration being fabricated.

Additionally, the controller 326 is configured to selectively cause the modular deposition nozzle 308 to eject the material. In some embodiments, the controller 326 sends control signals to the extrusion device 306 that regulate the flow of material through the modular deposition nozzle 308. The control signals may specify parameters such as extrusion rate, extrusion pressure, and extrusion timing. The controller 326 may selectively cause one or more interchangeable deposition nozzles to eject the material in a coordinated manner to deposit different battery materials at specified locations on the surface of the platform 312.

Further, the controller 326 is configured to selectively cause the drive mechanism to position the modular deposition nozzle 308 over the surface of the platform 312. In some embodiments, the controller 326 sends control signals to motors or actuators of the drive mechanism that move the print head 304 along multiple axes. The control signals may specify positional coordinates, movement speeds, and acceleration profiles for the drive mechanism. The controller 326 may selectively cause the drive mechanism to position one or more interchangeable deposition nozzles over the surface of the platform 312 according to a predetermined toolpath that defines the geometry of the battery being fabricated.

The controller 326 coordinates the printing process by synchronizing the operations of the modular materials unit 314, the modular deposition nozzle 308, and the drive mechanism. In some embodiments, the controller 326 executes a fabrication program that specifies the sequence of material supply, material ejection, and nozzle positioning operations. The fabrication program may define layer-by-layer deposition patterns that build up battery structures on the surface of the platform 312. The controller 326 may adjust the timing and parameters of each operation to maintain coordination between the modular materials unit 314 and the modular printing unit 302 throughout the printing process.

In some embodiments, the controller 326 also controls the power unit of the 3D printing system 300. For example, the controller 326 can monitor the state of charge of the energy storage component 322 and regulate the charging and discharging of the energy storage component 322. As another example, the controller 326 can send control signals to the energy storage component 322 that manage power distribution to the modular printing unit 302, the modular materials unit 314, and other components of the 3D printing system 300.

In other embodiments, the controller 326 includes automated calibration capabilities to reduce maintenance requirements of the 3D printing system 300. For example, the controller 326 can execute calibration routines that adjust operational parameters of the modular printing unit 302 and the modular materials unit 314 without manual intervention. Such automated calibration capabilities may include calibration of the drive mechanism to maintain positional accuracy, calibration of material flow rates from the multi-material reservoirs, and calibration of deposition parameters for the modular deposition nozzle 308. These automated calibration capabilities enable the 3D printing system 300 to maintain operational performance over extended periods with reduced maintenance requirements, which may be advantageous for deployment in remote or inaccessible environments where maintenance personnel are unavailable.

Turning to the sealed enclosure 328, the sealed enclosure 328 provides environmental protection for the components housed within the sealed enclosure 328. As described previously, the sealed enclosure 328 is configured to enclose the modular materials unit 314, the modular printing unit 302, and the energy storage component 322. However, in some embodiments, the sealed enclosure 328 encloses a subset of these components (e.g., just the modular printing unit 302). In such embodiments, the 3D printing system 300 includes another enclosure to contain the additional components.

In some embodiments, the sealed enclosure 328 is dustproof. The dustproof configuration of the sealed enclosure 328 prevents particulate matter from entering the interior of the sealed enclosure 328 and contaminating the modular printing unit 302, the modular materials unit 314, or the battery materials stored within the multi-material reservoirs. The dustproof configuration may be achieved through sealed joints, gaskets, filtered air intakes, or other sealing mechanisms that prevent dust ingress.

In other embodiments, the sealed enclosure 328 is waterproof. The waterproof configuration of the sealed enclosure 328 prevents moisture and liquid water from entering the interior of the sealed enclosure 328. The waterproof configuration enables the 3D printing system 300 to operate in humid environments, during precipitation events, or in maritime deployment scenarios where exposure to water is expected.

In yet further embodiments, an external surface of the sealed enclosure 328 includes radiation shielding. The radiation shielding protects the components within the sealed enclosure 328 from ionizing radiation. In some embodiments, the radiation shielding enables operation in high-radiation zones such as the lunar surface or other space-based or extraterrestrial deployments. The radiation shielding may comprise materials such as lead, polyethylene, or other radiation-attenuating materials integrated into or applied to the external surface of the sealed enclosure 328.

In still further embodiments, a chamber within the sealed enclosure 328 (i.e., the space within the sealed enclosure 328 or a particular portion of the space within the sealed enclosure 328) is pressurized. The pressurized chamber configuration enables the 3D printing system 300 to operate in low-pressure or vacuum environments. The pressurized chamber maintains an internal atmospheric pressure suitable for the operation of the modular printing unit 302 and the modular materials unit 314 regardless of the external atmospheric conditions. The pressurized configuration may include pressure regulation systems, pressure relief valves, and structural reinforcement to maintain the integrity of the sealed enclosure 328 under pressure differentials.

In additional embodiments, the sealed enclosure 328 includes a temperature regulation system. The temperature regulation system is configured to maintain a chamber within the sealed enclosure 328 at a temperature about a target temperature. The temperature regulation system enables operations in cryogenic or extreme heat environments. In some embodiments, the temperature regulation system includes heating elements that raise the temperature within the sealed enclosure 328 when the external environment is below the target temperature. In other embodiments, the temperature regulation system includes cooling elements that lower the temperature within the sealed enclosure 328 when the external environment is above the target temperature. The temperature regulation system may include thermal insulation, heat exchangers, thermoelectric devices, or other thermal management components that maintain the internal temperature of the sealed enclosure 328 within an operational range suitable for battery manufacturing processes.

In some embodiments, the 3D printing system 300 also includes a frame (not shown) that supports one or more of the modular materials unit 314, the modular printing unit 302, and the energy storage component 322 within the sealed enclosure 328. The frame can be composed of lightweight and durable composite materials. In some embodiments, the frame comprises a composite material that includes carbon fiber. In other embodiments, the frame comprises a composite material that includes titanium alloys. The composite material of the frame is configured to resist shock and to damp vibrations under extreme temperatures. The shock resistance and vibration damping characteristics of the frame protect the 3D printing system 300 components from mechanical disturbances during transportation and operation in harsh environments.

As shown in FIG. 3, the 3D printing system 300 includes a mobility mechanism 330 (illustrated as the mobility mechanism 330a and the mobility mechanism 330 b) that attaches the 3D printing system 300 to a mobility device that deploys the 3D printing system 300 in various environments. In some embodiments, the mobility mechanism 330 attaches the sealed enclosure 328 to an automobile, such as a truck or trailer, for land-based transportation. In other embodiments, the mobility mechanism 330 attaches the sealed enclosure 328 to a train or interface with a train track for rail-based transportation. In yet further embodiments, the mobility mechanism 330 attaches the sealed enclosure 328 to an airplane for airborne transportation. In still further embodiments, the mobility mechanism 330 attaches the sealed enclosure 328 to a drone for VTOL deployment to high-altitude or inaccessible regions. In additional embodiments, the mobility mechanism 330 attaches the sealed enclosure 328 to a high-altitude balloon for deployment at elevated altitudes or in near-space environments. In still additional embodiments, the mobility mechanism 330 attaches the sealed enclosure 328 to a ship for sea-based transportation and operation. The maritime deployment configuration enables the 3D printing system 300 to be installed on aircraft carriers, submarines, or maritime energy platforms for offshore battery production. Further, in some embodiments, the mobility mechanism 330 configures the sealed enclosure 328 for magnetically levitated configurations for zero-gravity and space applications. The magnetically levitated configurations enable the 3D printing system 300 to be positioned and stabilized in orbital platforms or extraterrestrial installations where conventional wheeled or tracked mobility mechanisms are unsuitable.

Across various embodiments, the mobility mechanism 330 comprises mounting brackets, coupling mechanisms, or attachment points that secure the sealed enclosure 328 to the mobility device during transportation. In some embodiments, the mobility mechanism 330 is integrated into the sealed enclosure 328. In other embodiments, the mobility mechanism 330 is a separate component(s) that is secured to the sealed enclosure 328. In some embodiments, the mobility mechanism 330 is permanently attached to the sealed enclosure 328 and remains in place during both transportation and operation. In other embodiments, the mobility mechanism 330 is a removable component that is attached to the sealed enclosure 328 for transportation and detached after the 3D printing system 300 reaches the deployment location. The removable configuration enables the 3D printing system 300 to be adapted for different transportation methods by swapping the mobility mechanism 330 for alternative mobility mechanisms suited to the transportation mode.

In some embodiments, the 3D printing system includes one or more sensors that are configured to obtain measurement data associated with a condition of an environment within the sealed enclosure. The one or more sensors monitor various parameters within the sealed enclosure to enable the controller to maintain operational performance and detect conditions that may affect battery manufacturing operations or pose safety concerns. In some embodiments, the sensors configured to obtain environmental condition data include temperature sensors, humidity sensors, pressure sensors, gas composition sensors, or radiation sensors. The environmental condition data enables the controller to monitor the internal atmosphere of the sealed enclosure and to detect conditions that may affect the quality of battery manufacturing operations or the safety of the 3D printing system.

In other embodiments, the 3D printing system includes multiple sensors that are configured to obtain data associated with a flow of material from the one or more interchangeable deposition nozzles. The sensors configured to obtain data associated with material flow can include—but are not limited to—flow rate sensors, pressure sensors, or optical sensors that monitor the ejection of material from the deposition nozzles during the printing process. The material flow data enables the controller to verify that materials are being deposited at specified rates and to detect anomalies such as clogged nozzles, material depletion, or inconsistent extrusion.

The multiple sensors may also be configured to obtain data associated with a layer formation on the surface of the platform. In some embodiments, the sensors configured to obtain data associated with layer formation include optical sensors, laser scanners, or imaging devices that capture information about the deposited layers during the additive manufacturing process. The layer formation data enables the controller to verify that battery components are being fabricated according to specified geometries and to detect defects such as incomplete layers, delamination, or dimensional inaccuracies.

The measurement data obtained by the sensors described above may be transmitted to the controller for processing and analysis. In some embodiments, the controller receives the measurement data from the sensors and compares the measurement data to predetermined thresholds or operational parameters. The controller may use the measurement data to adjust operational parameters of the modular printing unit or the modular materials unit to maintain manufacturing quality. In other embodiments, the controller transmits the measurement data to an artificial intelligence model that analyzes the data and generates instructions to modify parameters of the modular printing unit.

In some embodiments, the 3D printing system 300 includes a power fail-safe that is configured to cease power delivery from the power unit to one or more of the 3D printing system 300 components in response to the measurement data (e.g., the measurement data described above) indicating that the condition of the environment within the sealed enclosure is a dangerous condition. The power fail-safe provides a safety mechanism that protects the 3D printing system 300 and prevents hazardous situations from escalating when dangerous conditions are detected.

In some embodiments, the power fail-safe receives the measurement data from the one or more sensors and evaluates the measurement data to determine whether the condition of the environment within the sealed enclosure constitutes a dangerous condition. Examples of dangerous condition can include conditions such as excessive temperature, excessive pressure, presence of hazardous gases, radiation levels exceeding safe thresholds, or other environmental parameters that fall outside acceptable operational ranges.

The power fail-safe may cease power delivery to the modular materials unit 314 to prevent continued supply of battery materials when a dangerous condition is detected. In some embodiments, ceasing power delivery to the modular materials unit stops the operation of feed mechanisms, pumps, or other material handling devices within the modular materials unit. The cessation of material supply may prevent the release of additional materials into the sealed enclosure during a dangerous condition.

The power fail-safe may cease power delivery to the modular printing unit 302 to halt additive manufacturing operations when a dangerous condition is detected. In some embodiments, ceasing power delivery to the modular printing unit 302 stops the operation of the extrusion device 306, the drive mechanism, and heating elements within the modular printing unit. The cessation of printing operations may prevent continued deposition of materials and reduce the risk of damage to the 3D printing system or the battery components being fabricated.

In some embodiments, the power fail-safe is configured to cease power delivery to both the modular materials unit 314 and the modular printing unit 302 simultaneously when a dangerous condition is detected. In other embodiments, the power fail-safe is configured to selectively cease power delivery to specific components based on the type of dangerous condition indicated by the measurement data. For example, the power fail-safe may cease power delivery to heating elements when excessive temperature is detected while maintaining power to other components that do not contribute to the temperature condition.

The power fail-safe may be implemented as a hardware component, a software routine executed by the controller 326, or a combination of hardware and software. In some embodiments, the power fail-safe includes relays, circuit breakers, or solid-state switches that interrupt power delivery to the 3D printing system 300. In other embodiments, the power fail-safe includes software routines that send control signals to power distribution components to cease power delivery when dangerous conditions are detected.

The power fail-safe is expected to enable continued operation of the 3D printing system 300 in extreme conditions by providing emergency protection when environmental parameters exceed safe operational limits. The power fail-safe may be configured to automatically restore power delivery to the 3D printing system 300 when the measurement data indicates that the dangerous condition has been resolved.

As described above, the 3D printing system 300 can include multiple sensors that are configured to obtain data associated with a flow of material from the one or more interchangeable deposition nozzles 308, a layer formation on the surface of the platform 312, and a condition of an environment within the sealed enclosure 328. In some embodiments, the controller 326 is configured to transmit the data obtained by the multiple sensors to an artificial intelligence (AI) model associated with the 3D printing system 300. In some embodiments, the controller 326 transmits the data to the AI model via a wired connection, a wireless connection, or a network interface. The AI model may be implemented locally on a processing unit within the 3D printing system 300 (e.g., within a processing unit of the controller 326) or may be implemented remotely on a server or cloud computing platform that communicates with the controller 326 via a network connection.

Upon receiving the data, the AI model is configured to generate an instruction to modify a parameter of the modular printing unit 302 or a parameter of the modular materials unit 314. The AI model analyzes the data obtained by the multiple sensors and determines whether adjustments to the modular printing unit 302 or the modular materials unit 314 are warranted based on the analysis. In some embodiments, the AI model compares the received data to target values, historical data, or predictive models to identify deviations from expected performance. The AI model may employ machine learning algorithms, neural networks, or other computational techniques to process the sensor data and generate instructions for parameter modification.

Examples of parameters of the modular printing unit 302 that may be modified based on instructions from the AI model include material flow rate, extrusion pressure, extrusion temperature, deposition speed, layer thickness, nozzle positioning, and drive mechanism movement profiles. In some embodiments, the AI model generates instructions to increase or decrease the material flow rate from the one or more interchangeable deposition nozzles 308 based on data indicating that the actual flow rate deviates from a target flow rate. In other embodiments, the AI model generates instructions to adjust the positioning of the one or more interchangeable deposition nozzles 308 based on data indicating that layer formation on the surface of the platform 312 deviates from specified geometries.

The controller 326 is configured to receive, from the AI model, the instruction to modify the parameter of the modular printing unit 302. In some embodiments, the controller 326 receives the instruction via the same communication pathway used to transmit the sensor data to the AI model. The instruction may specify the parameter to be modified, the magnitude of the modification, and the timing of the modification. The controller 326 processes the received instruction and translates the instruction into control signals for the modular printing unit 302.

The controller 326 is configured to cause the modular printing unit 302 to modify the parameter in response to receiving the instruction from the AI model. In some embodiments, the controller 326 sends control signals to the extrusion device 306, the drive mechanism, or other components of the modular printing unit 302 to implement the parameter modification specified by the instruction. The modular printing unit 302 modifies the parameter according to the control signals received from the controller 326. The modification of the parameter may occur in real-time during the additive manufacturing process, enabling the 3D printing system to adapt to changing conditions without interrupting battery fabrication.

The AI model may continuously receive data from the multiple sensors and generate instructions to modify parameters of the modular printing unit 302 throughout the additive manufacturing process. In some embodiments, the AI model operates in a closed-loop control configuration where the AI model receives sensor data, generates instructions, and the controller causes the modular printing unit 302 to modify parameters in an iterative manner. The closed-loop control configuration enables the 3D printing system to maintain manufacturing quality by continuously adjusting operational parameters based on real-time feedback from the multiple sensors.

The instruction to modify the parameter of the modular printing unit 302 may be configured to compensate for a low gravity condition of the environment within the sealed enclosure. In some embodiments, the 3D printing system operates in microgravity environments such as orbital platforms, spacecraft, or extraterrestrial installations where gravitational forces are reduced compared to terrestrial environments. The low gravity condition affects the behavior of materials during the additive manufacturing process, including material flow from the one or more interchangeable deposition nozzles 308, material deposition onto the surface of the platform, and layer formation during battery fabrication.

The AI model is configured to analyze data associated with the condition of the environment within the sealed enclosure to detect low gravity conditions. In some embodiments, the multiple sensors include accelerometers, gravimeters, or other sensors that measure gravitational acceleration within the sealed enclosure. The AI model receives the gravitational acceleration data and determines whether the 3D printing system 300 is operating in a low gravity condition based on the received data.

When the AI model determines that the 3D printing system is operating in a low gravity condition, the AI model generates instructions to modify parameters of the modular printing unit 302 to compensate for the effects of reduced gravity on the additive manufacturing process. In some embodiments, the AI model generates instructions to adjust material flow rate, extrusion pressure, or deposition speed to account for changes in material behavior under low gravity conditions. The AI model may also generate instructions to modify the positioning and movement profiles of the one or more interchangeable deposition nozzles 308 to compensate for altered material trajectories in low gravity environments.

In some embodiments, the AI-driven process optimization uses capillary forces for gravity-independent 3D printing in microgravity environments. Capillary forces arise from surface tension effects at interfaces between materials and enable controlled material flow and deposition in the absence of gravitational forces. In some embodiments, the AI model generates instructions to modify parameters of the modular printing unit to leverage capillary forces for material transport and deposition. The instructions may specify adjustments to nozzle geometry, material viscosity, or deposition surface characteristics that enhance capillary-driven material flow. The modular printing unit 302 may include nozzle configurations or platform surface treatments that promote capillary action to facilitate material deposition in low gravity conditions.

In other embodiments, the AI-driven process optimization uses acoustic forces for gravity-independent 3D printing in microgravity environments. Acoustic forces are generated by sound waves and enable manipulation of materials without relying on gravitational forces. In some embodiments, the modular printing unit 302 includes acoustic transducers or ultrasonic devices that generate acoustic fields within the sealed enclosure. The AI model generates instructions to activate and control the acoustic transducers to manipulate material flow and deposition using acoustic forces. The instructions may specify acoustic frequency, amplitude, and spatial configuration to achieve controlled material positioning and layer formation in low gravity conditions.

The combination of capillary forces and acoustic forces is expected to enable the 3D printing system 300 to perform gravity-independent 3D printing in microgravity, lunar, and extraterrestrial environments. In some embodiments, the AI model generates instructions that coordinate the use of capillary forces and acoustic forces to compensate for the absence of gravitational forces during the additive manufacturing process. The AI model may analyze sensor data associated with material flow and layer formation to determine the appropriate combination of capillary-based and acoustic-based compensation techniques for a given low gravity condition.

The AI model may be trained using data collected from additive manufacturing operations performed under various gravitational conditions. In some embodiments, the AI model is trained using data from terrestrial operations, simulated low gravity operations, and actual low gravity operations to develop predictive models for material behavior under different gravitational conditions. The trained AI model applies the predictive models to generate instructions that compensate for low gravity conditions based on the sensor data received from the multiple sensors.

The AI-driven process optimization is expected to allow the 3D printing system 300 to adapt to varying gravitational conditions without manual intervention. In some embodiments, the AI model automatically detects changes in gravitational conditions based on sensor data and generates instructions to modify parameters of the modular printing unit accordingly. The automatic adaptation capability is expected to enable the 3D printing system to transition between terrestrial and extraterrestrial deployment scenarios while maintaining manufacturing quality for battery fabrication.

In some embodiments, the 3D printing system 300 includes a stealth mode with low thermal and electromagnetic signature for military applications. The stealth mode reduces the detectability of the 3D printing system 300 during operation. In some embodiments, the stealth mode includes thermal management features that reduce heat emissions from the sealed enclosure 328, such as heat sinks, thermal insulation, or active cooling systems that dissipate heat in a controlled manner to minimize infrared signatures. In other embodiments, the stealth mode includes electromagnetic shielding that attenuates radio frequency emissions from electronic components within the 3D printing system 300, such as the controller 326, the power unit, and the modular printing unit 302. The electromagnetic shielding may comprise conductive materials integrated into the sealed enclosure that absorb or reflect electromagnetic radiation to reduce the electromagnetic signature of the 3D printing system 300 during operation.

In other embodiments, the 3D printing system 300 is configured to use local regolith materials for sustainable battery production on lunar and Martian surfaces. Regolith refers to the layer of loose, heterogeneous material covering solid rock on planetary bodies, including the Moon and Mars. The modular materials unit 314 may be configured to process regolith materials collected from the deployment site and convert the regolith materials into battery components. In some embodiments, the multi-material reservoirs 316 are configured to store processed regolith-derived materials such as silicon extracted from lunar regolith for use as anode materials or iron oxides extracted from Martian regolith for use as cathode materials. The use of local regolith materials reduces the mass of materials that are transported from Earth to extraterrestrial deployment sites, which may reduce mission costs and enable extended battery production operations without resupply missions.

In yet further embodiments, the 3D printing system 300 includes ISS-compatible configurations for battery production during space missions and long-duration orbital operations. The ISS-compatible configurations may include form factors, power interfaces, and mounting systems that conform to International Space Station specifications for payload integration. The sealed enclosure 328 may be sized to fit within ISS module dimensions and may include attachment points compatible with ISS rack systems. The power unit may be configured to interface with ISS electrical systems to receive power from the station. The ISS-compatible configurations enable on-demand battery manufacturing for space missions, reducing dependency on battery resupply missions from Earth and supporting long-duration orbital operations where battery replacement or augmentation may be required.

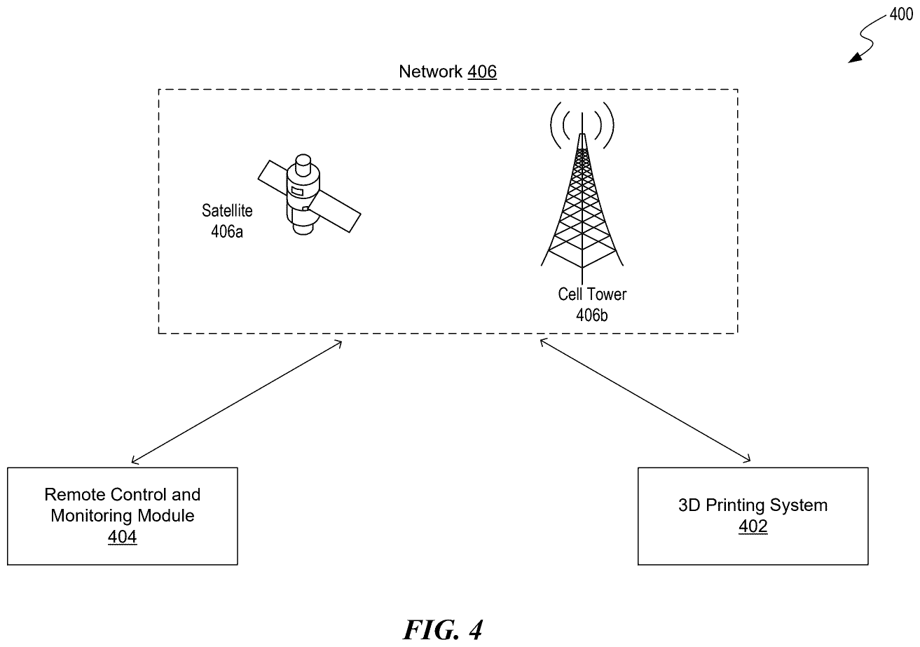

FIG. 4 is a block diagram of a remote control and monitoring environment of a modular and mobile additive battery manufacturing system. FIG. 4 includes an environment 400 with the 3D printing system 402, a remote control and monitoring module 404, and a network 406 that facilitates communication between the 3D printing system 402 and the remote control and monitoring module 404. The 3D printing system 402 may be configured similarly to the 3D printing system 100 described above with respect to FIG. 1 or the 3D printing system 300 described above with respect to FIG. 3.

The network 406 comprises a satellite 406a and a cell tower 406b. The satellite 406a and the cell tower 406b together enable connectivity across various deployment scenarios. The satellite 406a provides satellite uplink capabilities for communication in remote or inaccessible areas where traditional network infrastructure may be unavailable. The cell tower 406b, which may be implemented as a transmission tower or other wireless access point, provides wireless network access for terrestrial communications. Both the satellite 406a and the cell tower 406b provide communication pathways to both the remote control and monitoring module 404 and the 3D printing system 402. In some embodiments, the network 406 is limited to satellite communication (e.g., via satellite 406a) or cellular communication (e.g., via the cell tower 406b).

The remote control and monitoring module 404 is connected to the network 406, allowing operators to control and monitor the 3D printing system 402 from a remote location. In some embodiments, the remote control and monitoring module 404 communicates via satellite uplink through the satellite 406a for secure operation in remote deployment scenarios. In other embodiments, the remote control and monitoring module 404 communicates via an encrypted network through the cell tower 406b for secure operation in terrestrial deployment scenarios. The encrypted network may employ encryption protocols that protect communications between the remote control and monitoring module 404 and the 3D printing system 402 from unauthorized access or interception.

In some embodiments, the 3D printing system 402 receives commands and transmits operational data through the network 406. The network configuration supports encrypted communication and enables the 3D printing system 402 to operate autonomously in diverse environments while maintaining connectivity with remote operators through either satellite or terrestrial network connections. In some embodiments, the 3D printing system 402 transmits data associated with the 3D printing system 402 (e.g., material flow, layer formation, and environmental conditions within the sealed enclosure) to the remote control and monitoring module 404 via the network 406. The remote control and monitoring module 404 may display the transmitted data to operators and enable operators to issue commands to the 3D printing system 402 based on the displayed data.

As described previously, the controller of the 3D printing system (e.g., the controller 326 of FIG. 3) is configured to receive, from a remote control device, one or more instructions that are configured to cause the modular materials unit or the modular printing unit to perform one or more actions. In some embodiments, the remote control device comprises the remote control and monitoring module 404. The controller receives the one or more instructions from the remote control and monitoring module 404 via the network 406. The one or more instructions may be transmitted through the satellite 406a when the 3D printing system 402 is deployed in a remote location without terrestrial network coverage. The one or more instructions may alternatively be transmitted through the cell tower 406 b when the 3D printing system 402 is deployed in a location with terrestrial network access.

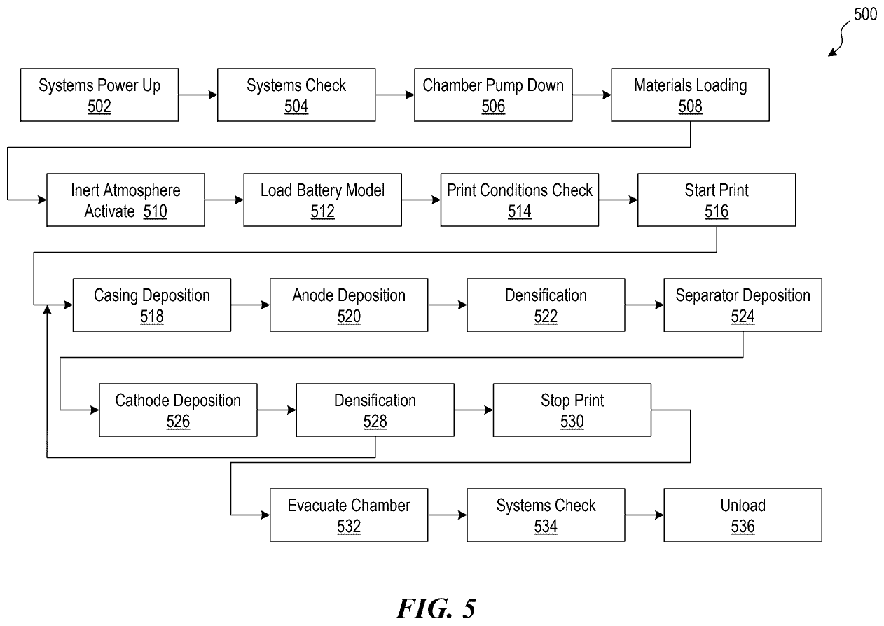

FIG. 5 is a flowchart of steps carried out by a 3D printing system when printing a battery in accordance with various embodiments of the present technology. The steps of FIG. 5 can be carried out using a 3D printing system such as the 3D printing system 300 of FIG. 3 or the 3D printing system 402 of FIG. 4 described above with respect to FIGS. 3 and 4.

At 502 systems power up is initiated (e.g., by the controller 326 of FIG. 3) to energize the components of the additive manufacturing device. At 504, the device performs a systems check to verify that the various subsystems including the print head, drive mechanism, laser emitters, and sensors are functioning within operational parameters. At 506, the device preforms a chamber pump down (e.g., via a pump of the 3D printing system) to evacuate ambient atmosphere from the sealed housing in preparation for establishing a controlled fabrication environment.

At 508, the device loads the materials to supply the deposition nozzles with the anode material, separator material, cathode material, and casing material (or another material required for the battery). At 510, the device introduces (e.g., via the pump) an inert gas such as argon or nitrogen through an inlet of the sealed housing. At 512, the device loads a battery model into a computing device of the device to provide the geometric and material specifications for the battery to be fabricated. At 514, the device checks print conditions to verify that deposition parameters, environmental conditions, and system calibrations are within acceptable ranges for fabrication. At 516, the device commences material deposition.

At 518, the device deposits the casing material onto the platform via the battery casing nozzle according to the loaded battery model. At 520 the device deposits the anode material in the designated regions of the battery structure via the anode nozzle. At 522, the device uses laser emitters to densify—or sinter—the deposited material to achieve desired microstructures and electrical properties of the deposited material.

At 524, the device deposits the separator material over the anode via the separator nozzle to provide electrical isolation while permitting ion transport. At 526, the device deposits the cathode material over the separator layer via the cathode nozzle. At 528, the device performs an additional densification step to sinter the separator and cathode materials. In some embodiments, the process includes a loop from the step 528 back to the step 518, indicating that the deposition and densification steps may be repeated for building multiple layers or cells within the energy storage device.

At 530, the device ceases the print operation upon completion of the final deposition and densification cycle. At 532, the device evacuates the sealed housing (also referred to herein as a “chamber”) to remove the inert atmosphere and prepare for device retrieval. At 534, the device performs a final systems check to verify system status and confirm successful completion of the fabrication process. At 536, the battery is unloaded from the platform of the additive manufacturing device.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 600. In some implementations, the computer system 600 can be an embedded computer system, a system-on-chip (SOC), a single-board computer (SBC) system, or a distributed system such as a mesh of computer systems or include one or more cloud components in one or more networks. Where appropriate, one or more computer systems 600 can perform operations in real time, near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computer system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Artificial Intelligence System

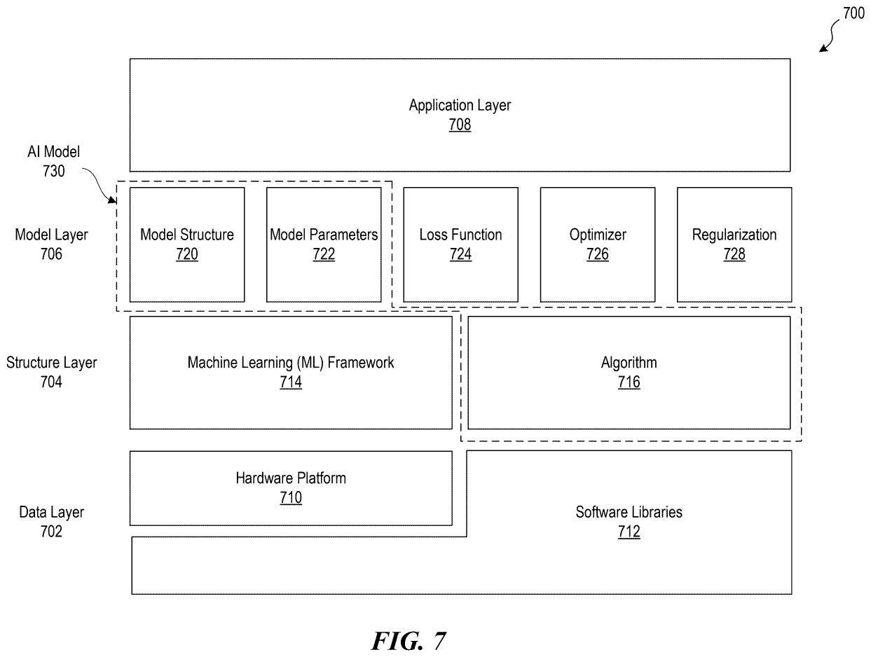

FIG. 7 is a block diagram that illustrates an example of an AI system 700 in which at least some operations described herein can be implemented. Example ML models can include the AI model described above with respect to FIG. 3. Accordingly, the AI model described above with respect to FIG. 3 can include one or more components of the AI system 700.

As shown in FIG. 7, the AI system 700 can include a set of layers, which conceptually organize elements within an example network topology for the AI system's architecture to implement a particular AI model 730. Generally, an AI model 730 is a computer-executable program implemented by the AI system 700 that analyzes data to make predictions. Information can pass through each layer of the AI system 700 to generate outputs for the AI model 730. The layers can include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for application of the AI model 730 by the application layer 708.

The data layer 702 acts as the foundation of the AI system 700 by preparing data for the AI model 730. As shown, the data layer 702 can include two sub-layers: a hardware platform 710 and one or more software libraries 712. The hardware platform 710 can be designed to perform operations for the AI model 730 and include computing resources for storage, memory, logic and networking. The hardware platform 710 can process amounts of data using one or more servers. The servers can perform backend operations such as matrix calculations, parallel calculations, ML training, and the like. Examples of servers used by the hardware platform 710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 710 can include Infrastructure as a Service (IaaS) resources, which are computing resources, (e.g., servers, memory, etc.) offered by a cloud services provider. The hardware platform 710 can also include computer memory for storing data about the AI model 730, application of the AI model 730, and training data for the AI model 730. The computer memory can be a form of random-access memory (RAM), such as dynamic RAM, static RAM, and non-volatile RAM.

The software libraries 712 can be thought of as suites of data and programming code, including executables, used to control the computing resources of the hardware platform 710. The programming code can include low-level primitives (e.g., fundamental language elements) that form the foundation of one or more low-level programming languages such that servers of the hardware platform 710 can use the low-level primitives to carry out specific operations. The low-level programming languages do not require much, if any, abstraction from a computing resource's instruction set architecture, allowing them to run quickly with a small memory footprint. Examples of software libraries 712 that can be included in the AI system 700 include Intel Math Kernel Library, Nvidia cuDNN, Eigen, and OpenBLAS.

The structure layer 704 can include an ML framework 714 and an algorithm 716. The ML framework 714 can be thought of as an interface, library, or tool that allows users to build and deploy the AI model 730. The ML framework 714 can include an open-source library, an application programming interface (API), a gradient-boosting library, an ensemble method, and/or a deep learning toolkit that work with the layers of the AI system to facilitate development of the AI model 730. For example, the ML framework 714 can distribute processes for application or training of the AI model 730 across multiple resources in the hardware platform 710. The ML framework 714 can also include a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730. Examples of ML frameworks 714 that can be used in the AI system 700 include TensorFlow, PyTorch, Scikit-Learn, Keras, Caffe, LightGBM, Random Forest, and Amazon Web Services.

The algorithm 716 can be an organized set of computer-executable operations used to generate output data from a set of input data and can be described using pseudocode. The algorithm 716 can include complex code that allows the computing resources to learn from new input data and create new/modified outputs based on what was learned. In some implementations, the algorithm 716 can build the AI model 730 through being trained while running computing resources of the hardware platform 710. This training allows the algorithm 716 to make predictions or decisions without being explicitly programmed to do so. Once trained, the algorithm 716 can run at the computing resources as part of the AI model 730 to make predictions or decisions, improve computing resource performance, or perform tasks. The algorithm 716 can be trained using supervised learning, unsupervised learning, semi-supervised learning, and/or reinforcement learning.

Using supervised learning, the algorithm 716 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include asset tracking histories with known threat levels, resources with known relevancy scores measuring their relevance to known assets, and logs of physical and digital features with known correspondences and similarities. The user may label the training data based on one or more classes and train the AI model 730 by inputting the training data to the algorithm 716. The algorithm determines how to label the new data based on the labeled training data. The user can facilitate collection, labeling, and/or input via the ML framework 714. In some instances, the user may convert the training data to a set of feature vectors for input to the algorithm 716. Once trained, the user can test the algorithm 716 on new data to determine if the algorithm 716 is predicting accurate labels for the new data. For example, the user can use cross-validation methods to test the accuracy of the algorithm 716 and retrain the algorithm 716 on new training data if the results of the cross-validation are below an accuracy threshold.

Supervised learning can involve classification and/or regression. Classification techniques involve teaching the algorithm 716 to identify a category of new observations based on training data and are used when input data for the algorithm 716 is discrete. Said differently, when learning through classification techniques, the algorithm 716 receives training data labeled with categories (e.g., classes) and determines how features observed in the training data (e.g., service name, asset room location, asset IP address) relate to the categories (e.g., high risk or low risk of cybersecurity attack). Once trained, the algorithm 716 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 716 is continuous. Regression techniques can be used to train the algorithm 716 to predict or forecast relationships between variables. To train the algorithm 716 using regression techniques, a user can select a regression method for estimating the parameters of the model. The user collects and labels training data that is input to the algorithm 716 such that the algorithm 716 is trained to understand the relationship between data features and the dependent variable(s). Once trained, the algorithm 716 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for ML-based pre-processing operations.

Under unsupervised learning, the algorithm 716 learns patterns from unlabeled training data. In particular, the algorithm 716 is trained to learn hidden patterns and insights of input data, which can be used for data exploration or for generating new data. Here, the algorithm 716 does not have a predefined output, unlike the labels output when the algorithm 716 is trained using supervised learning. Said another way, unsupervised learning is used to train the algorithm 716 to find an underlying structure of a set of data, group the data according to similarities, and represent that set of data in a compressed format. In some implementations, performance of the algorithm 716 that can use unsupervised learning is improved because it can learn how to fine-tune the model by setting an ideal cutoff score for relevancy rank, as described herein.

A few techniques can be used in supervised learning: clustering, anomaly detection, and techniques for learning latent variable models. Clustering techniques involve grouping data into different clusters that include similar data such that other clusters contain dissimilar data. For example, during clustering, data with possible similarities remain in a group that has less or no similarities to another group. Examples of clustering techniques include density-based methods, hierarchical-based methods, partitioning methods, and grid-based methods. In one example, the algorithm 716 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 716 may be trained to be an Isolation Forest, local outlier factor (LOF) algorithm, or k-NN algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 716 include factor analysis, item response theory, latent profile analysis, and latent class analysis.

The model layer 706 implements the AI model 730 using data from the data layer 702 and the algorithm 716 and ML framework 714 from the structure layer 704, thus enabling decision-making capabilities of the AI system 700. The model layer 706 includes a model structure 720, model parameters 722, a loss function engine 724, an optimizer 726, and a regularization engine 728.

The model structure 720 describes the architecture of the AI model 730 of the AI system 700. The model structure 720 defines the complexity of the pattern/relationship that the AI model 730 expresses. Examples of structures that can be used as the model structure 720 include decision trees, support vector machines, regression analyses, Bayesian networks, Gaussian processes, genetic algorithms, and neural networks. The model structure 720 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 720 may include one or more hidden layers of nodes between the input and output layers. The model structure 720 can be a neural network that connects the nodes in the structured layers such that the nodes are interconnected. Examples of neural networks include deep neural networks (DNNs), which are a type of neural network having multiple layers and/or a large number of neurons. DNNs may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

The model parameters 722 represent the relationships learned during training and can be used to make predictions and decisions based on input data. The model parameters 722 can weight and bias the nodes and connections of the model structure 720. For instance, when the model structure 720 is a neural network, the model parameters 722 can weight and bias the nodes in each layer of the neural networks such that the weights determine the strength of the nodes and the biases determine the thresholds for the activation functions of each node. The model parameters 722, in conjunction with the activation functions of the nodes, determine how input data is transformed into desired outputs. The model parameters 722 can be determined and/or altered during training of the algorithm 716.

The loss function engine 724 can determine a loss function, which is a metric used to evaluate the AI model's 730 performance during training. For instance, the loss function engine 724 can measure the difference between a predicted output of the AI model 730 and the actual output of the AI model 730 and is used to guide optimization of the AI model 730 during training to minimize the loss function. The loss function may be presented via the ML framework 714 such that a user can determine whether to retrain or otherwise alter the algorithm 716 if the loss function is over a threshold. In some instances, the algorithm 716 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 726 adjusts the model parameters 722 to minimize the loss function during training of the algorithm 716. In other words, the optimizer 726 uses the loss function generated by the loss function engine 724 as a guide to determine what model parameters lead to the most accurate AI model 730. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 726 used may be determined based on the type of model structure 720 and the size of data and the computing resources available in the data layer 702.

The regularization engine 728 executes regularization operations. Regularization is a technique that prevents overfitting and underfitting of the AI model 730. Overfitting occurs when the algorithm 716 is overly complex and too adapted to the training data, which can result in poor performance of the AI model 730. Underfitting occurs when the algorithm 716 is unable to recognize even basic patterns from the training data such that it cannot perform well on training data or on validation data. The regularization engine 728 can apply one or more regularization techniques to fit the algorithm 716 to the training data properly, which helps constrain the resulting AI model 730 and improves its ability for generalized application. Examples of regularization techniques include lasso (L1) regularization, ridge (L2) regularization, and elastic (L1 and L2 regularization).

The application layer 708 describes how the AI system 700 is used to solve problems or perform tasks. In an example implementation, the application layer 708 can include the 3D printing operations described with respect to FIG. 3.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A 3D printing system for 3D printing batteries, the 3D printing system comprising:
a modular materials unit that includes multiple multi-material reservoirs that are each configured to contain multiple battery materials separately, the multiple battery materials comprising a battery casing material, an anode material, a separator material, and a cathode material;
a modular printing unit that includes:
a platform having a surface;
one or more interchangeable deposition nozzles that are each configured to (i) receive a material of the multiple battery materials and (ii) eject the material towards the surface of the platform; and
a drive mechanism that is configured to position the one or more interchangeable deposition nozzles over the surface of the platform;
a controller that is configured to selectively cause -
the modular materials unit to supply the multiple battery materials to the one or more interchangeable deposition nozzles,
the one or more interchangeable deposition nozzles to eject the material, and
the drive mechanism to position the one or more interchangeable deposition nozzles over the surface of the platform;
a power unit that includes:
an energy generation component; and
a regenerative energy storage component;
a sealed enclosure that is configured to enclose the modular materials unit, the modular printing unit, and the regenerative energy storage component; and
a mobility mechanism that is configured to attach the sealed enclosure to a mobility device that moves the 3D printing system from a first location to a second location.

2. The 3D printing system of claim 1, further comprising:
a frame that supports one or more of the modular materials unit, the modular printing unit, and the regenerative energy storage component within the sealed enclosure,
wherein the frame comprises a composite material that is configured to resist shock and damp vibrations under extreme temperatures.

3. The 3D printing system of claim 1, wherein the mobility device comprises:
an automobile;
a train;
a train track;
an airplane;
a drone;
a ship;
a magnetically levitated mobility device; or
a high-altitude balloon.

4. The 3D printing system of claim 1, wherein the power unit further comprises:
the energy generation component, the energy generation component comprising:
a solar array that is mounted to a surface of the sealed enclosure; or
an electrical couple configured to electrically couple the power unit to an energy generation device; and
the regenerative energy storage component,
wherein the regenerative energy storage component is a battery energy storage system.

5. The 3D printing system of claim 1, further comprising:
one or more sensors that are configured to obtain measurement data associated with a condition of an environment within the sealed enclosure; and
a power fail-safe that is configured to, in response to the measurement data indicating that the condition of the environment within the sealed enclosure is a dangerous condition, cease power delivery from the power unit to one or more of the modular materials unit and the modular printing unit.

6. The 3D printing system of claim 1,
wherein the sealed enclosure is dustproof,
wherein the sealed enclosure is waterproof,
wherein an external surface of the sealed enclosure includes radiation shielding, and
wherein a chamber within the sealed enclosure is pressurized.

7. The 3D printing system of claim 1, the sealed enclosure further comprising:
a temperature regulation system that is configured to maintain a chamber within the sealed enclosure at a temperature about a target temperature.

8. The 3D printing system of claim 1, wherein the controller is further configured to:
receive, from a remote control device, one or more instructions that are configured to cause the modular materials unit or the modular printing unit to perform one or more actions, and
cause, in response to receiving the one or more instructions, the modular materials unit or the modular printing unit to perform the one or more actions.

9. The 3D printing system of claim 1, wherein the 3D printing system further includes multiple sensors that are configured to obtain data associated with a flow of material from the one or more interchangeable deposition nozzles, a layer formation on the surface of the platform, and a condition of an environment within the sealed enclosure, wherein the controller is further configured to:
transmit the data to an artificial intelligence (AI) model associated with the 3D printing system,
wherein, upon receiving the data, the AI model is configured to generate an instruction to modify a parameter of the modular printing unit;
receive, from the AI model, the instruction to modify the parameter of the modular printing unit; and
cause the modular printing unit to modify the parameter.

10. The 3D printing system of claim 9,
wherein the instruction to modify the parameter of the modular printing unit is configured to compensate for a low gravity condition of the environment within the sealed enclosure.

11. The 3D printing system of claim 1, wherein the multiple multi-material reservoirs further comprise:
a first multi-material reservoir that is configured to contain a first subset of battery materials separately, the first subset of battery materials comprising solid-state electrolyte materials;
a second multi-material reservoir that is configured to contain a second subset of battery materials separately, the second subset of battery materials comprising electrode materials;
a third multi-material reservoir that is configured to contain a third subset of battery materials separately, the third subset of battery materials comprising battery casing materials; and
a fourth multi-material reservoir that is configured to contain a fourth subset of battery materials separately, the fourth subset of battery materials comprising separator materials.

12. A 3D printing device for 3D printing batteries, the 3D printing device comprising:
a modular materials unit that includes a multi-material reservoir that is configured to contain multiple battery materials separately, the multiple battery materials comprising a battery casing material, an anode material, a separator material, and a cathode material;
a modular printing unit that includes:
an interchangeable deposition nozzle that is configured to (i) receive a material of the multiple battery materials and (ii) eject the material towards a surface of a platform of the modular printing unit; and
a drive mechanism that is configured to position the interchangeable deposition nozzle over the surface of the platform;
a controller that is configured to selectively cause -
the modular materials unit to supply the multiple battery materials to the modular printing unit,
the interchangeable deposition nozzle to eject the material, and
the drive mechanism to position the interchangeable deposition nozzle over the surface of the platform;
a battery energy storage system that provides energy to one or more of the modular materials unit, the modular printing unit, and the controller;
a sealed enclosure that is configured to enclose the modular materials unit, the modular printing unit, and the battery energy storage system;
a solar array that is mounted to an external surface of the sealed enclosure, the solar array configured to charge the battery energy storage system; and
a mobility mechanism that is configured to attach the sealed enclosure to a mobility device that moves the 3D printing device from a first location to a second location.

13. The 3D printing device of claim 12, wherein the mobility device comprises:
an automobile;
a train;
a train track;
an airplane;
a drone;
a ship;
a magnetically levitated mobility device; or a high-altitude balloon.

14. The 3D printing device of claim 12, the sealed enclosure further comprising:
a temperature regulation system that is configured to maintain a chamber within the sealed enclosure at a temperature about a target temperature.

15. The 3D printing device of claim 12, wherein the controller is further configured to:
receive, from a remote control device, one or more instructions that are configured to cause the modular materials unit or the modular printing unit to perform one or more actions, and
cause, in response to receiving the one or more instructions, the modular materials unit or the modular printing unit to perform the one or more actions.

16. The 3D printing device of claim 12, wherein the 3D printing device further includes multiple sensors that are configured to obtain data associated with a flow of material from the interchangeable deposition nozzle, a layer formation on the surface of the platform, and a condition of an environment within the sealed enclosure, wherein the controller is further configured to:
transmit the data to an artificial intelligence (AI) model associated with the 3D printing device,
wherein, upon receiving the data, the AI model is configured to generate an instruction to modify a parameter of the modular printing unit;
receive, from the AI model, the instruction to modify the parameter of the modular printing unit; and
cause the modular printing unit to modify the parameter.

17. A 3D printing system for 3D printing batteries, the 3D printing system comprising:
a materials unit that includes multiple multi-material reservoirs that are each configured to contain multiple battery materials separately;
a modular printing unit that includes:
a platform having a surface;
one or more interchangeable deposition nozzles that are each configured to (i) receive a material of the multiple battery materials and (ii) eject the material towards the surface of the platform; and
a drive mechanism that is configured to position the one or more interchangeable deposition nozzles over the surface of the platform;
a controller that is configured to selectively cause -
the one or more interchangeable deposition nozzles to eject the material, and
the drive mechanism to position the one or more interchangeable deposition nozzles over the surface of the platform;
a sealed enclosure that is configured to enclose the materials unit and the modular printing unit; and
a mobility mechanism that is configured to attach the sealed enclosure to a mobility device.

18. The 3D printing system of claim 17, wherein the mobility device is configured to move the 3D printing system from a first location to a second location, and wherein the mobility device comprises:
an automobile;
a train;
a train track;
an airplane;
a drone;
a ship;
a magnetically levitated mobility device; or
a high-altitude balloon.

19. The 3D printing system of claim 17, further comprising:
a power unit that includes:
an energy generation component comprising
a solar array that is mounted to a surface of the sealed enclosure; or
an electrical couple configured to electrically couple the power unit to an energy generation device; and
a regenerative energy storage component.

20. The 3D printing system of claim 17, wherein the 3D printing system further includes multiple sensors that are configured to obtain data associated with a flow of material from the one or more interchangeable deposition nozzles, a layer formation on the surface of the platform, and a condition of an environment within the sealed enclosure, wherein the controller is further configured to:
transmit the data to an artificial intelligence (AI) model associated with the 3D printing system,
wherein, upon receiving the data, the AI model is configured to generate an instruction to modify a parameter of the modular printing unit;
receive, from the AI model, the instruction to modify the parameter of the modular printing unit; and
cause the modular printing unit to modify the parameter.
